(19) United States
(12) Patent Application Publication
(10) Pub. No.: US 2024/0353166 A1
(43) Pub. Date: Oct. 24, 2024

(54) REFRIGERATOR

(71) Applicant: LG ELECTRONICS INC., Seoul (KR)

(72) Inventor: Seongjin KIM, Seoul (KR)

(73) Assignee: LG ELECTRONICS INC., Seoul (KR)

(21) Appl. No.: 18/583,064

(22) Filed: Feb. 21, 2024

(30) Foreign Application Priority Data
Apr. 20, 2023 (KR) 10-2023-0052318
Sep. 13, 2023 (KR) 10-2023-0121886

(51) Int. Cl. F25D 23/02; E05F 5/08

(52) U.S. Cl. CPC F25D 23/028; E05F 5/08; E05Y 2900/31; F25D 2323/024

(57) ABSTRACT

A refrigerator includes a cabinet which has a storage space; a door which opens and closes the storage space; a hinge which is provided in the cabinet and rotatably connects the door; and a hinge cover which shields the hinge, in which the hinge cover is provided with a damping device which is in contact with the door to provide a damping force to the door when the door rotates in a closing direction.

### CROSS-REFERENCE TO RELATED APPLICATIONS

The present application claims priority under 35 U.S.C. 119 to Korean Patent Application No. 10-2023-0052318, filed in the Republic of Korea on Apr. 20, 2023, and Korean Patent Application No. 10-2023-0121886, filed in the Republic of Korea on Sep. 13, 2023, all of which are hereby incorporated by reference in their entireties.

### BACKGROUND

The present disclosure relates to a refrigerator.

In general, a refrigerator is a home appliance that allows food to be stored at low temperatures in an internal storage space shielded by a door. To this end, refrigerators are designed to keep stored food in optimal condition by cooling the inside of the storage space using cold air generated through heat exchange with the refrigerant circulating in the refrigeration cycle.

Recently, refrigerators are gradually becoming larger and more multi-functional in accordance with changes in eating habits and the trend of higher quality products, and refrigerators with various structures that take user convenience into consideration are being released.

When a device is provided to provide space for door storage of a refrigerator or to provide additional functions such as an ice maker and dispenser, the weight of the door increases. Additionally, when heavy materials such as glass and metal are used to enhance the outer appearance of the refrigerator door, the weight of the door increases even when a transparent panel assembly is provided so that the storage space of the door can be viewed from the outside. Additionally, even when a large amount of food is stored in the door or heavy food is stored, the weight of the door increases.

When the weight of the refrigerator door increases, there is a problem that it takes a lot of effort to open and close the refrigerator door, and the speed at the moment when the door is closed becomes very fast, and thus problems such as noise or items falling may occur due to impact.

Additionally, when a device is added to force the door to close, there is a problem that the closing force applied to the door is added, requiring more force when opening the door, and there is a problem that the door may be opened due to the repulsive force at the moment when the door is closed.

In addition, when a damper is placed to reduce the closing speed of the door, a damping force is applied even when the door is opened, resulting in a problem that a lot of force is required when opening the door.

### SUMMARY

An object of an embodiment of the present disclosure is to provide a refrigerator that can alleviate impact and noise when the door is closed and ensure a smooth closing operation.

An object of an embodiment of the present disclosure is to provide a refrigerator with improved productivity and assembly workability.

An object of an embodiment of the present disclosure is to provide a refrigerator that can effectively secure a damping section while minimizing external exposure of the damper device.

A refrigerator according to an embodiment of the present disclosure includes a cabinet which has a storage space; a door which opens and closes the storage space; a hinge which is provided in the cabinet and rotatably connects the door; and a hinge cover which shields the hinge, in which the hinge cover may be provided with a damping device which is in contact with the door to provide a damping force to the door when the door rotates in a closing direction.

The hinge may be provided on an upper surface of the cabinet, and a hinge mounting part to which the hinge is axially coupled may be recessed in an upper portion of a rear surface of the door corresponding to the hinge.

The hinge cover may include a first part which accommodates the hinge and protrudes toward the front of the cabinet; and a second part which protrudes upward from the upper surface of the first part and on which the damping device is mounted, and the first part may protrude further forward than the second part and is formed to be stepped from the second part.

An upper end of the hinge mounting part may be formed to be higher than an upper end of the first part and lower than an upper end of the second part, and the damping device may be in contact with the rear surface of the door above the hinge mounting part when the door is closed.

The damping device may be mounted inside the second part, and the damping device may include a push member which is in contact with a rear surface of the door when the door is closed, and the push member may protrude through the front surface of the second part.

The hinge cover may include a first part which accommodates the hinge and protrudes toward the front of the cabinet; and a second part which protrudes from an outer surface of the first part and on which the damping device is mounted, the first part may protrude further forward than the second part, and the damping device may extend to pass through the second part and is selectively in contact with the inner surface of the hinge mounting part.

The first part and the second part may extend to be inserted into the door mounting part when the door is closed.

The damping device may include a push member which extends to pass through the second part and which is in contact with the rear surface of the door and is retracted when the door is closed, a contact part may be formed at a front end of the push member, and a guide part formed in a shape corresponding to the contact part may be formed on an inner surface of the hinge mounting part.

The guide part may be configured to be inclined or rounded so that the guide part protrudes forward as the guide part gets closer to the rotation center of the hinge.

The second part may protrude upward from the upper surface of the first part.

The second part may protrude from a side of the first part, and the side may be a surface which is closer to the outside of the cabinet among the left and right sides of the first part.

The damping device may include a cylinder which forms a compressed space in which oil is accommodated and has an open surface; a push member which is provided on the cylinder; a sealing cap which shields the opening of the cylinder; a rod which passes through the sealing cap and extends from the inside of the cylinder; a piston which is coupled to the rod, moves relative to the compression space, and forms an orifice through which the oil passes; and an clastic member which is accommodated in the compression space and provides elastic force to the piston, and the push member may extend to penetrate the hinge cover and may be pressed while moving in contact with the rear surface of the door.

A plurality of damping parts may be formed in the extending direction at an open end of the cylinder, each of the plurality of damping parts may be formed to have a larger inner diameter as the distance from the opening increases, and the damping force gradually may become smaller as the piston is retracted.

The damping force which reduces the rotational speed of the door may be applied to a damping part closest to the opening among the plurality of damping parts, and the door may be in the low-speed state as the piston is further retracted and passes through another damping part.

As another aspect, a refrigerator according to an embodiment of the present disclosure includes a cabinet which has a storage space; a door which is rotatably connected to the cabinet and opens and closes the storage space by rotation; and a door dike which protrudes rearward from the rear surface of the door and is inserted into the storage space when the door is closed, and in which the door dike may include a damping device which is in contact with the cabinet and provides a damping force to the door when the door rotates in a closing direction.

The damping device may be disposed within the door dike, the damping device may include a push member protruding through an outer surface of the door dike, and the push member may be pressed in contact with an inner wall of the storage space when the door is closed.

A storage member mounting part on which the storage member may be mounted protrudes from the door dike, and the damping device may be disposed within the storage member mounting part.

One end of the damping device opposite to the push member may be supported inside the storage member mounting part.

The damping device may be disposed in a direction perpendicular to the left and right sides of the storage space.

The door may include a main door which is rotatably mounted on the cabinet and forms an opening communicating with the storage space; and a sub-door which opens and closes the opening in front of the main door, and the door dike and the damping device may be provided on the main door.

The refrigerator according to an embodiment of the present disclosure has the following effects.

According to the present embodiment, when the door is closed at a set angle or more, the damping device is in contact with one side of the door or cabinet to provide a damping force. Accordingly, the door can be slowed down and closed smoothly, impact noise applied to the door can be prevented, and food stored in the door can be prevented from shaking.

In addition, since the damping device is provided on the hinge cover, there is no need to add a separate structure or configuration for mounting the damping device, so productivity and assembly workability can be improved. In addition, there is an advantage that service work for maintenance of the damping device can also be easily performed.

Additionally, the damping device may have a structure that protrudes from the hinge cover, and thus has the advantage of minimizing exposure to the user when opening and closing the door.

In particular, the second part on which the damping device is mounted has a structure that protrudes from the first part, thereby securing a sufficient section to provide a damping force to the door. Therefore, sufficient damping force can be provided within the section where the door is rotated to close, allowing the door to close smoothly.

Additionally, the damping device is disposed inside the door wherein the damping device may be disposed to pass through the door dike. Therefore, there is an advantage in that the damping force can be effectively applied when the door is closed while minimizing exposure when opening and closing the door.

Additionally, the damping device has the advantage of being placed on the storage member mounting part of the door, eliminating the need for additional placement space, and enabling efficient disposition.

### BRIEF DESCRIPTION OF THE DRAWINGS

FIG. 1 is a perspective view illustrating a refrigerator according to a first embodiment of the present disclosure.

FIG. 2 is a front view illustrating a state where a door of the refrigerator is open.

FIG. 3 is an exploded perspective view illustrating the combined structure of a hinge and the door of the refrigerator.

FIG. 4 is a perspective view illustrating the combined structure of a hinge device and a hinge cover.

FIG. 5 is a cross-sectional view illustrating the structure and operating state of a damping device according to an embodiment of the present disclosure.

FIG. 6 is a partial perspective view illustrating a state where the door is rotated in a closing direction.

FIG. 7 is a partial perspective view illustrating a state where the door of a refrigerator according to a second embodiment of the present disclosure is rotated in the closing direction.

FIG. 8 is a cross-sectional view taken along line 8-8 in FIG. 7 when the door is closed.

FIG. 9 is a partial perspective view illustrating a state where the door of a refrigerator according to a third embodiment of the present disclosure is rotated in the closing direction.

FIG. 10 is a cross-sectional view taken along line 10-10 of FIG. 9 when the door is closed.

FIG. 11 is a cross-sectional view illustrating a state where the door of a refrigerator according to a fourth embodiment of the present disclosure is rotated in the closing direction.

FIG. 12 is a cross-sectional view illustrating a state where the door is closed.

FIG. 13 is a partial perspective view illustrating a refrigerator according to a fifth embodiment of the present disclosure.

FIG. 14 is a cross-sectional view taken along line 15-15 of FIG. 13 when the door of the refrigerator is opened.

FIG. 15 is a cross-sectional view taken along line 15-15 of FIG. 13 when the door is closed.

FIG. 16 is a cross-sectional view illustrating the structure of a damping device for a refrigerator according to the sixth embodiment of the present disclosure.

### DETAILED DESCRIPTION OF THE EMBODIMENTS

Hereinafter, specific embodiments of the present disclosure will be described in detail along with the drawings. However, the present disclosure cannot be said to be limited to the embodiments in which the idea of the present disclosure is presented, and other disclosures that are regressive or other embodiments included within the scope of the present disclosure can be easily suggested by adding, changing, or deleting other components.

In addition, some of the configurations of the embodiments of the present disclosure are the same, the same configurations are denoted by the same reference numerals, and detailed descriptions thereof are not repeated. Additionally, the configurations of multiple embodiments may be combined or replaced in whole or in part with other embodiments.

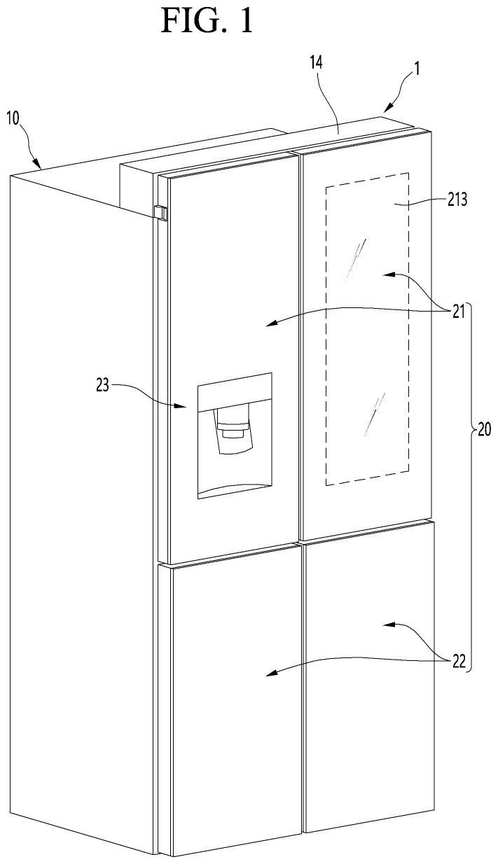

Before explaining the embodiments, various directions are defined. In an embodiment of the present disclosure, the direction in which a front surface of the door illustrated in FIG. 1 faces may be referred to as a front direction, the direction toward the cabinet based on the front surface of the door may be referred to as a rear direction, the direction toward the floor where the refrigerator is installed may be referred to as a lower direction, and the direction away from the floor may be referred to as an upper direction. In addition, when indicating a previously undefined direction, the direction can be defined and explained based on each drawing.

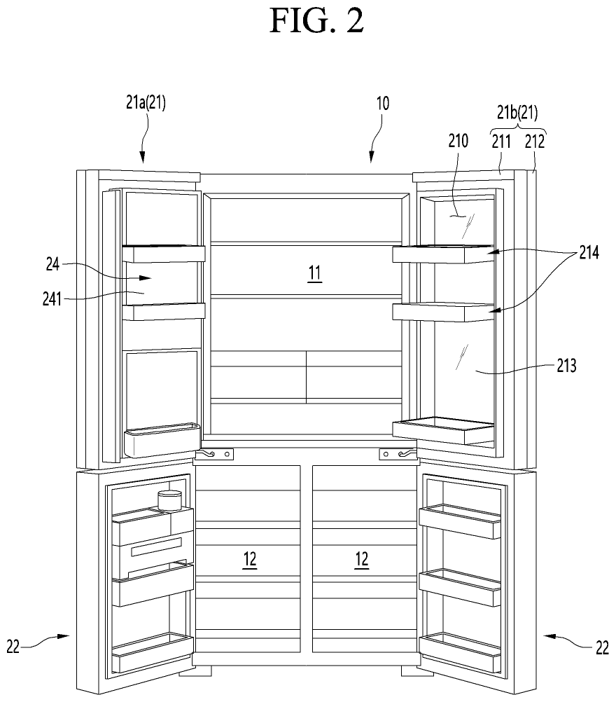

FIG. 1 is a perspective view illustrating a refrigerator according to a first embodiment of the present disclosure, and FIG. 2 is a front view illustrating a state where a door of the refrigerator is open.

As illustrated in the drawing, the overall outer appearance of the refrigerator 1 according to an embodiment of the present disclosure may be formed by a cabinet 10 forming a storage space with an open front surface, and a door 20 opening and closing the storage space.

The cabinet 10 may include a storage space with an open front surface. The inside of the cabinet 10 may be composed of an upper storage space 11 and a lower storage space 12 divided up and down. For example, the upper storage space 11 may be a refrigerating chamber and the lower storage space may be a freezing chamber.

A door 20 may be provided in front of the cabinet 10. The door 20 may be provided with a panel on the front that forms an outer appearance. The panel may be made of various materials such as glass, metal, ceramic, and plastic.

There may be a plurality of doors 20, and each door 20 may be configured to independently open and close the storage space by rotating it. As an example, the door 20 may include an upper door 21 that opens and closes the upper storage space 11 and a lower door 22 that opens and closes the lower storage space 12.

The upper door 21 and the lower door 22 are coupled by a hinge device, and the upper storage space 11 and the lower storage space 12 can be opened and closed by rotation. Additionally, a pair of the upper door 21 and the lower door 22 may be disposed side by side on both left and right sides.

The upper door 21 may be composed of a left door 21a and a right door 21b. The left door 21a may be referred to as a first door, and the right door 21b may be referred to as a second door. In addition, the upper door 21 may be referred to as a refrigerating chamber door. The upper door 21 may be provided with various structures for user convenience.

As an example, a dispenser 23 may be provided on the front surface of the left door 21a. Additionally, an ice maker may be accommodated at the rear surface of the left door 21a and an ice making chamber 24 may be provided that is opened and closed by the ice making chamber door 241. Ice inside the ice making chamber 24 may be discharged through the dispenser 23.

As another example, the right door 21b may be configured as a double door including a main door 211 and a sub-door 212. The main door 211 opens and closes the upper storage space 11 and may include an opening 210 in communication with the upper storage space 11. Additionally, a storage member 214 may be provided in the opening 210. The storage member 214 may be formed in a basket-like shape and may be detachably disposed on the main door 211.

The sub-door 212 can open and close the opening 210 in front of the main door 211. Additionally, the sub-door 212 may be provided with a transparent panel assembly 213 that can see through the opening 210.

The door 20 may be configured in various ways according to the disposition of the storage space. In the present embodiment, an example provided with four doors will be described, but it should be noted in advance that the present disclosure is applicable to all refrigerators equipped with at least one rotating door.

Hereinafter, the mounting structure will be discussed based on the left door 21a of the upper doors 21. The present disclosure is not limited to the position and shape of the door 20. Additionally, the left door 21a may be referred to as a door 20 for convenience of explanation and understanding.

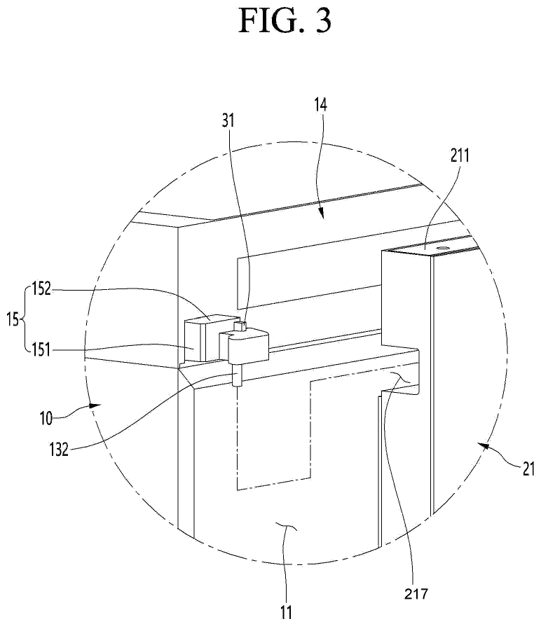

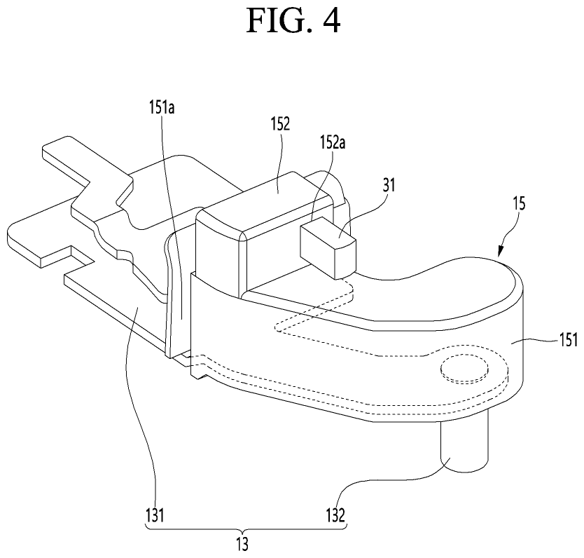

FIG. 3 is an exploded perspective view illustrating the combined structure of a hinge and the door of the refrigerator, and FIG. 4 is a perspective view illustrating the combined structure of a hinge device and a hinge cover.

A hinge mounting part 217 on which the hinge 13 is mounted may be formed at the upper portion of the door 20. The hinge mounting part 217 may be partially open on the side and rear surface of the door 20, and the hinge 13 may be axially coupled to the inside of the hinge mounting part 217.

A cabinet cover 14 may be provided on the upper surface of the cabinet 10. The cabinet cover 14 may extend upward from the upper surface of the cabinet 10. Additionally, the front surface of the cabinet cover 14 may be positioned on the same plane as the front surface of the cabinet 10.

A display may be provided on the cabinet cover 14 to display the operating state of the refrigerator 1. Additionally, a control part for controlling the operating state of the refrigerator 1 may be disposed inside the cabinet cover 14.

The cabinet 10 may be equipped with a hinge 13. The hinge 13 may include a hinge plate 131 and a hinge pin 132. The hinge 13 may be made of a metal material. The hinge plate 131 may be fixedly mounted on the upper surface of the cabinet 10 and may protrude and extend toward the front of the cabinet 10. A hinge pin 132 may protrude downward from an end portion of the hinge plate 131. The hinge pin 132 may be axially coupled to the door 20 inside the hinge mounting part 217. Accordingly, the door 20 can be rotated around the hinge pin 132.

The hinge 13 may be shielded by a hinge cover 15. The hinge cover 15 may have open rear and lower surfaces and may form a space to accommodate the hinge plate 131 therein.

Additionally, the rear end of the hinge cover 15 may be mounted in the opening 141 of the cabinet cover 14. In other words, the hinge 13 mounted on the cabinet 10 may protrude forward through the opening 141 of the cabinet cover 14 and may be accommodated inside the hinge cover 15. Additionally, the hinge 13 may be inserted into the hinge mounting part 217 while being accommodated in the hinge cover 15.

The hinge cover 15 may include a first part 151 in which the hinge 13 is accommodated, and a second part 152 in which the damping device 30 is mounted. The first part 151 may be referred to as a hinge accommodation part, and the second part 152 may be referred to as a damping device accommodation part.

The first part 151 forms the lower portion of the hinge cover 15 and may be formed to correspond to the shape of the hinge 13 protruding toward the front of the cabinet 10. In other words, the first part extends along the extended shape of the hinge 13 and can be inserted into the hinge mounting part 217. At this time, the upper surface of the first part 151 may be formed to be equal to or slightly lower than the height of the open upper end of the hinge mounting part 217. Therefore, when the door 20 is rotated for opening and closing, the first part 151 does not interfere with the door 20.

The lower surface of the first part 151 is open, and the hinge plate 131 may be located at the lower portion of the first part 151. Additionally, the hinge pin 132 may protrude further downward past the open lower surface of the first part 151.

Additionally, a cover coupling part 151a coupled to the cabinet cover 14 may be formed at the rear end of the first part 151. The cover coupling part 151a may form a groove into which the open end portion of the cabinet cover 14 can be inserted.

The second part 152 may be provided on the upper surface of the first part 151. The second part 152 has a structure that protrudes from the first part 151. In addition, the first part 151 and the second part 152 may have a stepped structure. Additionally, the first part 151 may have a structure that protrudes further forward than the front end of the second part 152.

The second part 152 may have a structure that protrudes upward and forward from the rear end of the upper surface of the first part 151. Additionally, a space in which the damping device 30 is mounted may be provided inside the second part 152.

When the hinge cover 15 is mounted, the rear end of the first part 151 and the rear end of the second part 152 may be in contact with the front surface of the cabinet cover 14.

In addition, when the door 20 is closed, the front surface of the second part 152 may face the rear surface of the door 20. In other words, when the door 20 is closed, the front surface of the second part 152 may be adjacent to the rear surface of the door cap decoration 211.

An opening 152a through which the damping device 30 passes may be formed on the front surface of the second part 152. The push member 31 of the damping device 30 may protrude through the opening 152a. Additionally, the push member 31 may be retracted into and withdrawn from the opening 152a as the push member is in contact with the door 20.

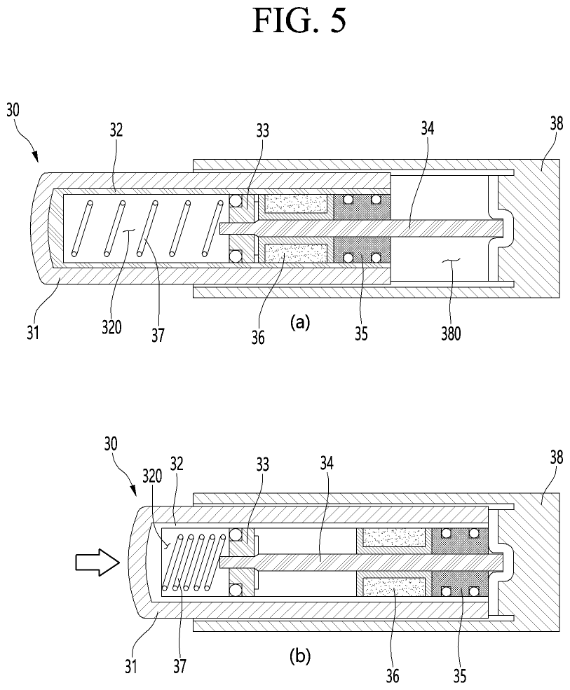

FIG. 5 is a cross-sectional view illustrating the structure and operating state of a damping device according to an embodiment of the present disclosure. In addition, in FIG. 5, (a) illustrates a state before the door 20 and the damping device 30 is in contact with each other, and (b) illustrates a state where the door 20 is completely closed and thus the door 20 presses the damping device 30.

As illustrated, the damping device 30 may include a cylinder 32, a piston 33, and a rod 34.

The cylinder 32 is formed in a cylindrical shape with one side open, and may form a buffer space 320 inside which oil is accommodated. The cylinder 32 may be made of a metal material and will not be deformed or damaged even when high pressure is applied to the buffer space 320.

A piston 33 may be movably disposed within the cylinder 32. The inner diameter of the buffer space 320 may be formed to be constant throughout the entire section and may be formed in a shape corresponding to the outer diameter of the piston 33. Therefore, as the piston 33 moves, the oil in the buffer space 320 can be pressed.

A rod 34 is connected to the center of the piston 33, and the rod 34 may extend past the opening of the cylinder 32 inside the buffer space 320. The end portion of the rod 34 may be supported inside the housing 38.

The open end portion of the cylinder 32 may be shielded by a sealing cap 35. Additionally, a seal may be provided around the sealing cap 35. A plurality of the seals may be disposed in series.

Additionally, a sponge 36 may be provided inside the cylinder 32. The sponge 36 may be provided between the piston 33 and the sealing cap 35. The sponge 36 is compressed so that the oil passing through the orifice of the piston 33 can be moved when the piston 33 advances, thereby compensating for the volume for the movement of the oil.

The piston 33 may be supported by the elastic member 37 within the buffer space 320. One end of the clastic member 37 may be in contact with the piston 33 and the other end thereof may be in contact with one end of the cylinder 32. The clastic member 37 may be composed of a spring.

An orifice through which oil moves within the buffer space may be formed in the piston 33. The structure and shape of the orifice can be designed in various ways on the piston 33. As an example, the orifice may be formed by passing through the piston 33. As another example, the orifice may be formed between the piston 33 and the rod 34. The piston 33 is connected to the rod 34 and can relatively move together with the rod 34 within the buffer space 320.

The rod 34 may penetrate the sealing cap 35 and the sponge 36. When the rod is moved, the sealing cap 35 and the sponge 36 may remain fixed inside the cylinder 32. In addition, the rod 34 may extend to penetrate the piston 33. When the rod 34 moves, the piston 33 moves together and can press the elastic member 37 and the oil.

The damping device 30 may further include a push member 31 coupled to the cylinder 32. The push member 31 is a portion that is directly in contact with the rear surface of the door 20, and can be formed in various shapes that can be effectively in contact with the door 20. As an example, the push member 31 may be formed in a shape to accommodate the cylinder 32. The push member 31 may be made of plastic material. Of course, the push member 31 and the cylinder 32 may be formed integrally, or may be formed as a single structure.

The damping device 30 may further include a housing 38. In addition, the housing 38 may be formed with an accommodation space 380 that is open on one side. In addition, the push member 31 can be accommodated inside the accommodation space 380. The housing 38 is open at one end so that the push member 31 can be inserted. If necessary, the housing 38 may be omitted.

One end of the push member 31 is exposed to the outside of the housing 38, and the other end thereof may remain inserted into the accommodation space 380. In addition, when the push member 31 is pressed, the push member 31 can be inserted into the housing 38 while being buffered by the flow of oil inside the damping device 30. Additionally, the housing 38 may be fixedly mounted inside the second part 152.

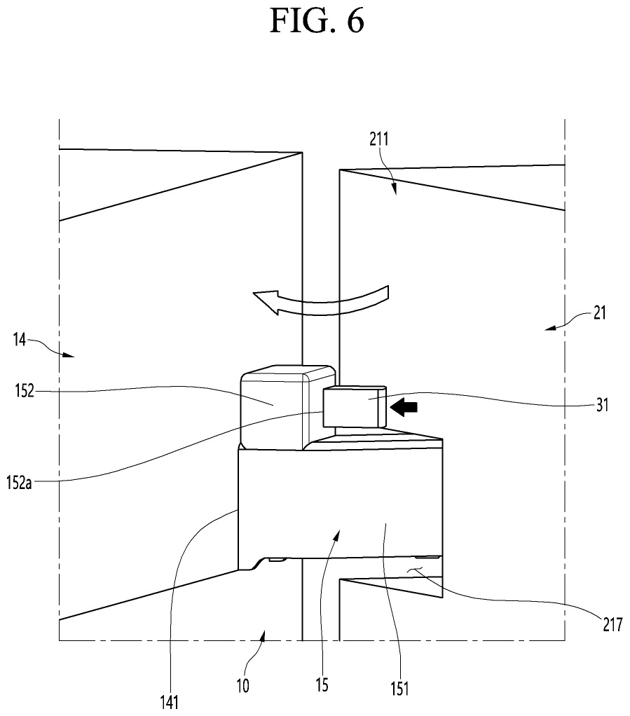

FIG. 6 is a partial perspective view illustrating a state where the door is rotated in a closing direction.

As illustrated in the drawing, when the door 20 is opened at a set angle or more, the push member 31 may protrude, and the end portion of the push member 31 may be not in contact with the door 20. Accordingly, the damping device 30 may be in a state as illustrated in (a) of FIG. 5 in which the damping force is not applied.

At this time, the hinge 13 and the first part 151 of the hinge cover 15 is inserted into the hinge mounting part 217 and connected to the door 20. Accordingly, the second part 152 located on the upper end of the first part 151 may be positioned at a position that can be contacted when the door 20 rotates. In particular, the second part 152 is disposed close to the rotation shaft of the door 20, so that when the door 20 rotates, the section in contact with the rear surface of the door 20 is expanded and can be effectively contacted.

When the door 20 is rotated in the closing direction and the opening angle of the door 20 is the set angle or less, the door 20 and the push member 31 is in contact with each other. For example, the set angle may be approximately 30°. The front end of the push member 31 is in contact with the rear surface of the door 20, and, in particular, is in contact with the rear of the door 20 above the hinge mounting part 217. In other words, a sufficient damping section can be secured by contact between the push member 31 and the rear surface of the door 20, which is located further rearward than the hinge mounting part 217.

When the door 20 is closed and the front end of the push member 31 is in contact with the rear surface of the door 20 and is pressed, the push member 31 moves to the right (as seen in (b) of FIG. 5) and can be inserted into the inside of the housing 38. At this time, the piston 33 may relatively move to the left (as seen in (b) of FIG. 5) within the buffer space 320. In addition, the oil in the buffer space 320 moves along the orifice to the space where the sponge 36 is disposed. The oil in the buffer space 320 flows at a constant flow rate along the orifice, thereby providing constant oil resistance. Accordingly, the push member 31 moves at a constant speed inside the housing 38, and thus the door 20 is decelerated and can be closed at a constant speed.

When the door 20 is completely closed, the rear surface of the door 20 pushes the push member 31 rearward, and the push member 31 may be retracted into the second part 152. Accordingly, the push member 31 protrudes from the front surface of the second part 152, but may be formed to protrude more than the distance between the front surface of the second part 152 and the rear surface of the door 20.

In other words, when the door 20 is completely closed, the damping device 30 is in a state as illustrated in (b) of FIG. 5. In detail, when the door 20 is completely closed, the push member 31 is fully retracted into the second part 152. Additionally, the piston 33 may be moved to the leftmost position within the buffer space 320. In addition, the elastic member 37 can be compressed by the movement of the push member 31, and the elastic member 37 can be in a maximum compression state by the piston 33.

Therefore, when the door 20 is set open, if the external force applied to the push member 31 is removed, the push member 31 returns to the original position thereof due to the elasticity of the elastic member 37, and oil in the space where the sponge 36 is disposed may flow back to the buffer space 320 through the orifice.

Meanwhile, the present disclosure may have various other embodiments in addition to the above-described embodiments. Other embodiments of the present disclosure differ only in the structure related to the disposition of the damping device, and other configurations may be the same.

Hereinafter, the description will focus on the features of other embodiments of the present disclosure, and detailed description and illustration of the same configuration as the above-described embodiments may be omitted. Additionally, the same configuration may be indicated using the same reference numeral.

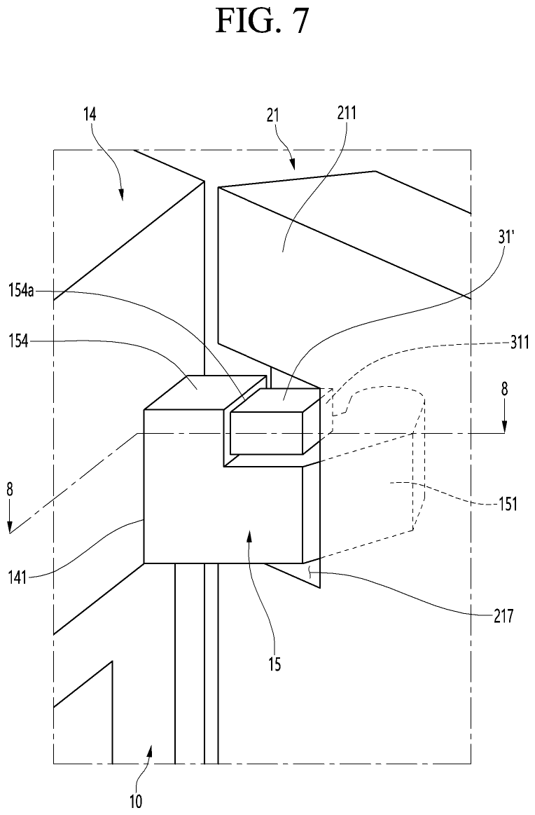

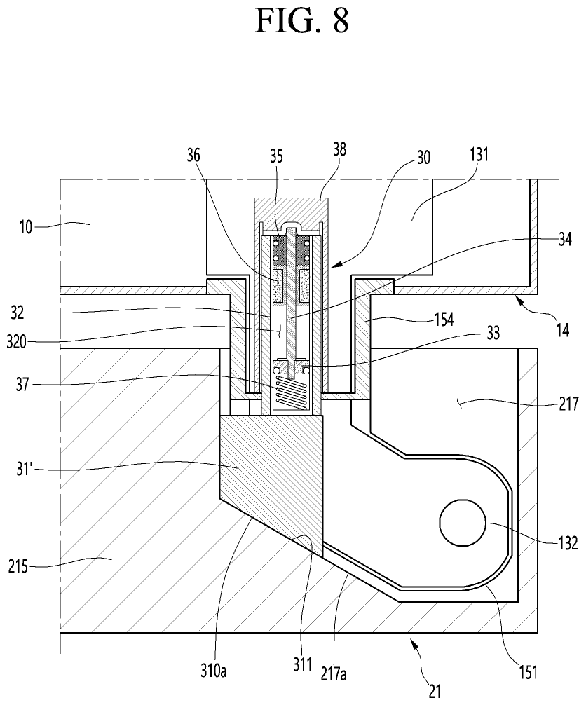

FIG. 7 is a partial perspective view illustrating a state where the door of a refrigerator according to a second embodiment of the present disclosure is rotated in the closing direction, and FIG. 8 is a cross-sectional view taken along line 8-8 in FIG. 7 when the door is closed.

As illustrated, the refrigerator 1 according to the second embodiment of the present disclosure may be provided with a hinge 13 on the upper surface of the cabinet 10. The hinge 13 may include a hinge plate 131 and a hinge pin 132. The cabinet cover 14 may be further provided on the upper surface of the cabinet 10.

In addition, the hinge 13 can be accommodated inside the hinge cover 15. The hinge cover 15 may protrude toward the front of the cabinet 10 and may extend to be inserted into the hinge mounting part 217 formed on the door 20.

The hinge cover 15 may include a first part 151 that accommodates the hinge 13 and a second part 154 formed on the upper surface of the first part 151. The second part 154 protrudes upward from the upper surface of the first part 151 and may be formed to be stepped from the first part 151. The first part 151 may protrude further forward than the front end of the second part 154.

In addition, at least a portion of the second part 154 may be inserted into the hinge mounting part 217 when the door 20 is completely closed. Additionally, the push member 31′ of the damping device 30 may protrude from the front surface of the second part 154. The push member 31′ may protrude through the opening 154a on the front surface of the second part 154.

A contact part 311 may be formed on the push member 31′. The contact part 311 is a portion that is in contact with the inner surface of the hinge mounting part 217 and may be formed in a shape corresponding to the shape of the inner surface of the hinge mounting part 217. Additionally, the contact part 311 may be formed on the front surface of the push member 31′.

Additionally, the hinge mounting part 217 may be formed on the door 20. The hinge mounting part 217 may have an opening at a corner of the rear surface and one side of the door 20. In addition, the opened vertical height of the hinge mounting part 217 may be formed to a height that can accommodate both the first part 151 and the second part 154 of the hinge cover 15. In other words, the vertical height of the hinge mounting part 217 may correspond to the height from the lower surface of the first part 151 to the upper surface of the second part 154.

Meanwhile, a guide part 217a may be formed on the inner surface of the hinge mounting part 217. The guide part 217a may be formed on the inner front surface or side of the hinge mounting part 217. The guide part 217a is a portion that is in contact with the contact part 311 of the push member 31′ and may be formed in shapes corresponding to each other.

The guide part 217a may be formed to be inclined or rounded. As an example, the guide part 217a may be formed to have an inclination that protrudes forward as it gets closer to the hinge pin 132. Additionally, the contact parts 311 may also be formed to have corresponding inclinations. Therefore, when the door 20 is closed, the contact part 311 and the guide part 217a can be in surface contact with each other, and by applying pressure to the damping device 30 in the front and rear direction, damping force can be effectively generated, while damage to the damping device can be prevented by preventing lateral load from being applied.

Of course, the outer surface of the push member 31′ and the inner surface of the hinge mounting part 217 may have various shapes that correspond to each other.

When the door 20 of the refrigerator 1 having such a structure is closed from an open state to a set angle or less, the push member 31′ protruding from the second part 154 can be inserted into the inside of the hinge mounting part 217. Then, the contact part 311 of the push member 31′ starts to be in contact with the guide part 217a.

Then, when the door 20 is rotated in a further closing direction, the push member 31′ moves rearward, and the piston 33 and rod 34 move. In addition, the damping device 30 generates a damping force due to oil resistance generated as the oil in the buffer space 320 flows through the orifice. Accordingly, the door 20 is closed smoothly as the rotation speed is reduced.

When the door 20 is completely closed, as illustrated in FIG. 8, the push member 31′ can be fully inserted into the hinge mounting part 217. In addition, the contact part 311 and the guide part 217a remain in contact with each other.

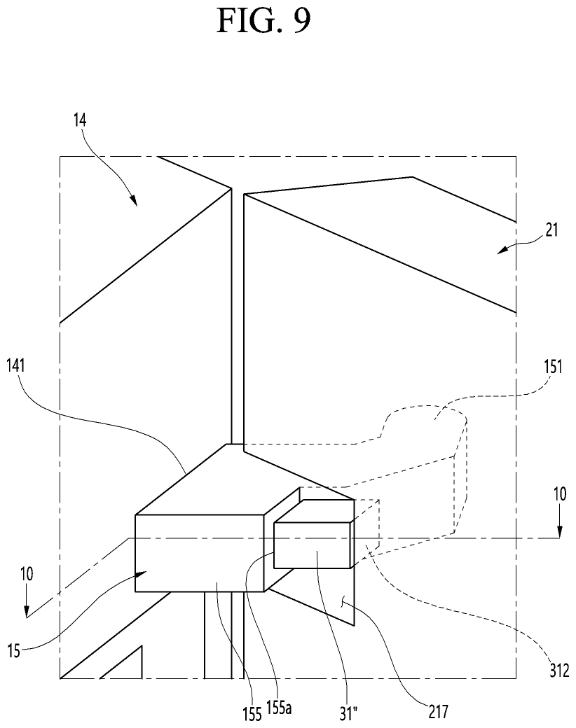

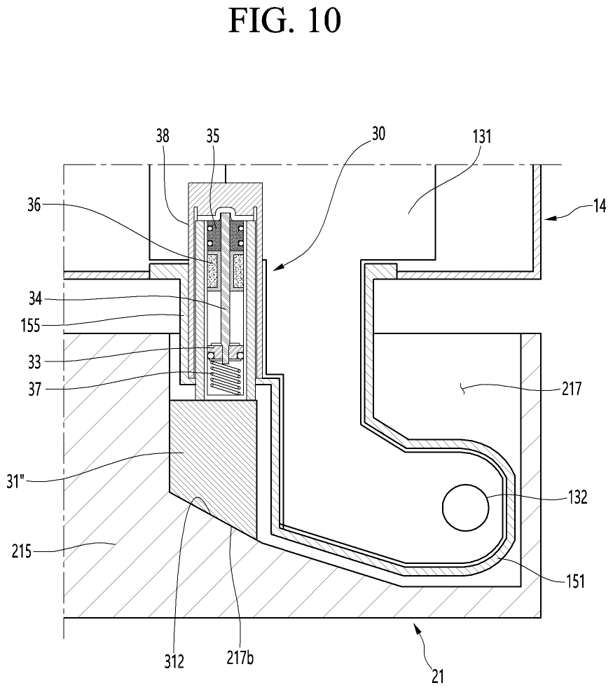

FIG. 9 is a partial perspective view illustrating a state where the door of a refrigerator according to a third embodiment of the present disclosure is rotated in the closing direction, and FIG. 10 is a cross-sectional view taken along line 10-10 of FIG. 9 when the door is closed.

As illustrated, the refrigerator I according to the third embodiment of the present disclosure may be provided with a hinge 13 on the upper surface of the cabinet 10. The hinge 13 may include a hinge plate 131 and a hinge pin 132. The cabinet cover 14 may be further provided on the upper surface of the cabinet 10.

In addition, the hinge 13 can be accommodated inside the hinge cover 15. The hinge cover 15 may protrude toward the front of the cabinet 10 and may extend to be inserted into the hinge mounting part 217 formed on the door 20.

The hinge cover 15 may include a first part 151 that accommodates the hinge 13 and a second part 155 formed on a side of the first part 151. The second part 155 protrudes laterally from the side of the first part 151 and may be disposed to be stepped from the side of the first part 151. The first part 151 may protrude further forward than the front end of the second part 155. Additionally, the push member 31″ of the damping device 30 may protrude from the front surface of the second part 155. The push member 31″ may protrude through the opening 155a on the front surface of the second part 155.

At this time, the second part 155 may be formed on one side of the left and right sides that is farthest from the side of the cabinet 10. Additionally, the second part 155 may be formed along the side of the first part 151 at the rear end of the first part 151. In addition, at least a portion of the second part 155 may be inserted into the hinge mounting part 217 when the door 20 is completely closed.

The first part 151 may protrude further forward than the front surface of the second part 155. Additionally, the push member 31″ protrudes forward from the front surface of the second part 155 and may extend parallel to the first part 151. At this time, the protruding front end of the push member 31″ may be positioned further forward than the protruding front end of the first part 151.

A contact part 312 may be formed on the push member 31″. The contact part 312 is a portion that is in contact with the inner surface of the hinge mounting part 217 and may be formed in a shape corresponding to a shape of the inner surface of the hinge mounting part 217. Additionally, the contact part 312 may be formed on the front surface of the push member 31″.

Additionally, the hinge mounting part 217 may be formed on the door 20. The hinge mounting part 217 may have an opening at a corner of the rear surface and one side of the door 20. Additionally, the opened left and right widths of the hinge mounting part 217 may be formed to accommodate both the first part 151 and the second part 155 of the hinge cover 15. In other words, the left and right widths of the hinge mounting part 217 may correspond to the distance from the outer end of the first part 151 to the outer end of the second part 155.

Meanwhile, a guide part 217b may be formed on the inner surface of the hinge mounting part 217. The guide part 217b may be formed on the inner front surface or side of the hinge mounting part 217. The guide part 217b is a portion that is in contact with the contact part 312 of the push member 31″ and may be formed in shapes corresponding to each other.

The guide part 217b may be formed to be inclined or rounded. As an example, the guide part 217b may be formed to have an inclination that protrudes forward as it gets closer to the hinge pin 132. Additionally, the contact parts 312 may also be formed to have corresponding inclinations. Therefore, when the door 20 is closed, the contact part 312 and the guide part 217b can be in surface contact with each other, and, by applying pressure to the damping device 30 in the front and rear direction, damping force can be effectively generated, while damage to the damping device can be prevented by preventing lateral load from being applied.

Of course, the outer surface of the push member 31″ and the inner surface of the hinge mounting part 217 may have various shapes that correspond to each other.

When the door 20 of the refrigerator 1 having such a structure is closed from an open state to a set angle or less, the push member 31″ protruding from the second part 155 can be inserted into the inside of the hinge mounting part 217. Then, the contact part 312 of the push member 31″ starts to contact the guide part 217b.

Then, when the door 20 is rotated in a further closing direction, the push member 31″ moves rearward, and the piston 33 and rod 34 move. In addition, the damping device 30 generates a damping force due to oil resistance generated as the oil in the buffer space 320 flows through the orifice. Accordingly, the door 20 is closed smoothly as the rotation speed is reduced.

When the door 20 is completely closed, as illustrated in FIG. 10, the push member 31″ can be fully inserted into the hinge mounting part 217. In addition, the contact part 312 and the guide part 217b remain in contact with each other.

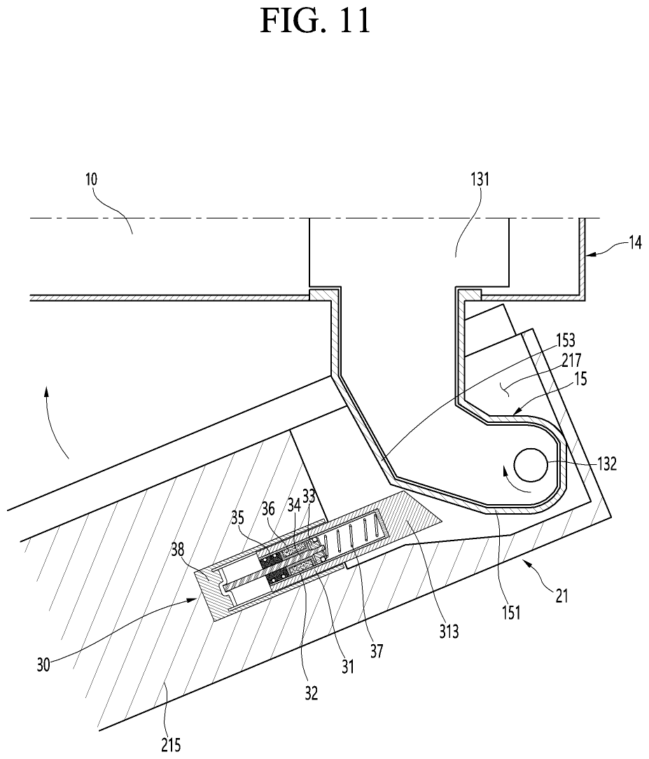

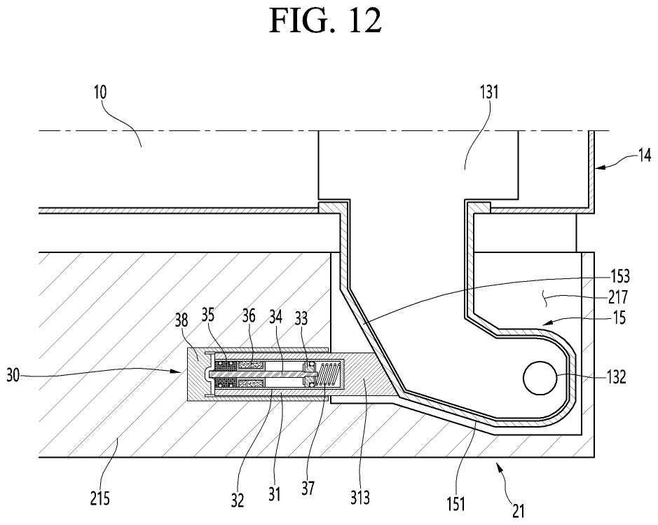

FIG. 11 is a cross-sectional view illustrating a state where the door of a refrigerator according to a fourth embodiment of the present disclosure is rotated in the closing direction, and FIG. 12 is a cross-sectional view illustrating a state where the door is closed.

As illustrated, the refrigerator according to the fourth embodiment of the present disclosure may include a cabinet 10 and a door 21.

A hinge 13 may be provided on the upper surface of the cabinet 10. The hinge 13 may include a hinge plate 131 and a hinge pin 132. The cabinet cover 14 is further provided on the upper surface of the cabinet 10 to shield a portion of the hinge plate 131.

In addition, the hinge 13 may be accommodated inside the hinge cover 15. The hinge cover 15 may include a first part 151 protruding toward the front of the cabinet 10 and may extend to be inserted into the hinge mounting part 217 formed on the door 21.

The first part 151 may accommodate the hinge plate 131 protruding toward the front of the cabinet 10. In addition, the hinge part may be opened downward so that the hinge pin 132 can be axially coupled to the hinge mounting part 217.

The first part 151 may be extended to be inclined or rounded so that the hinge pin 132 is mounted close to a corner formed by the front surface and sides of the door 21. The first part 151 may be formed to correspond to the extended shape of the hinge plate 131 accommodated therein.

Additionally, a guide part 153 may be further formed on the outer surface of the hinge cover 15. The guide part 153 may be in contact with the damping device 30 to apply a damping force. The guide part 153 may have an inclination that moves away from the hinge pin 132 from the front to the rear. Therefore, in the process of closing the door 21, the closing speed of the door 21 can be reduced by increasing the damping force of the damping device 30.

The guide part 153 may have various shapes that can be in contact with the push member 31 of the damping device 30. As an example, the guide part 153 may protrudes or is recessed in a round shape. In addition, the guide part 153 may be composed of a plurality of inclined parts to adjust the speed according to the closing angle of the door 21.

The hinge mounting part 217 may be formed on the door 21. The hinge mounting part 217 may have an opening at a corner of the rear surface and one side of the door 21. Additionally, the hinge mounting part 217 may be formed to accommodate the hinge cover 15 when the door 21 is closed.

Meanwhile, the hinge mounting part 217 may be provided with a damping device 30. The structure of the damping device 30 may be the same as the above-described embodiment, with only partial differences in the mounting position of the damping device 30 and the shape of the push member 31.

The damping device 30 may be mounted on one side of the left and right sides of the hinge mounting part 217 that is farthest from the hinge pin 132. The damping device 30 may be configured such that the housing 38 is inserted into the inside of the door 21 and fixedly mounted, and the push member 31 protrudes toward the inside of the hinge mounting part 217. In other words, a mounting space into which the housing is inserted and mounted may be recessed on one surface of the hinge mounting part 217, and the mounting space may be formed in a shape corresponding to the housing 38.

The push member 31 protrudes from the housing 38 and may be in contact with the hinge cover 15 as the door 21 rotates. In addition, the push member 31 can relatively move the piston 33 to generate a damping force due to oil resistance while being retracted into the inside of the housing 38 by being in contact with the hinge cover 15.

At this time, the protruding end portion of the push member 31 may be formed with a contact part 313 formed in a shape corresponding to the guide part 153. Therefore, when the door 21 rotates in the closing direction, the contact part 313 can naturally contact the guide part 153.

As an example, the contact part 313 may be formed to be inclined toward the hinge pin 132 from the rear to the front. In addition, the inclination of the contact part 313 may correspond to the inclination of the guide part 153. Therefore, when the door 20 is closed, the contact part 313 and the guide part 153 can be in surface contact with each other, and, by applying pressure to the damping device 30 in the front and rear direction, a damping force can be effectively generated, while damage to the damping device 30 can be prevented by preventing a lateral load from being applied.

When the door 21 of the refrigerator I having such a structure is closed from an open state to a set angle or less, the push member 31 may be in a state of protruding toward the inside of the hinge mounting part 217, as illustrated in FIG. 11. In addition, when the door 21 is further rotated in the closing direction, the end portion of the push member 31 becomes closer to the outer surface of the hinge cover 15.

In addition, when the door 21 is closed at the set angle or less, the end portion of the push member 31 starts with the guide part 153 of the hinge cover 15. As an example, the set angle may be approximately 30°.

When the door 21 is rotated in a further closing direction, the push member 31 moves rearward, and the piston 33 and rod 34 move. In addition, the damping device 30 generates a damping force due to oil resistance generated as the oil in the buffer space 320 flows through the orifice. Accordingly, the door 21 is closed smoothly as the rotation speed is reduced.

When the door 21 is completely closed, as illustrated in FIG. 12, the push member 31 can be fully inserted into the housing. In addition, the contact part 313 and the guide part 153 remain in close contact with each other.

The contact part 313 and the guide part 153 have corresponding inclinations to each other and maintain a state of surface contact with each other. In addition, when the door 21 is opened, the contact part 313 and the guide part 153 can be immediately separated from each other as the door 21 rotates, a reaction force is not applied to the door 21, and thus the door can be opened easily.

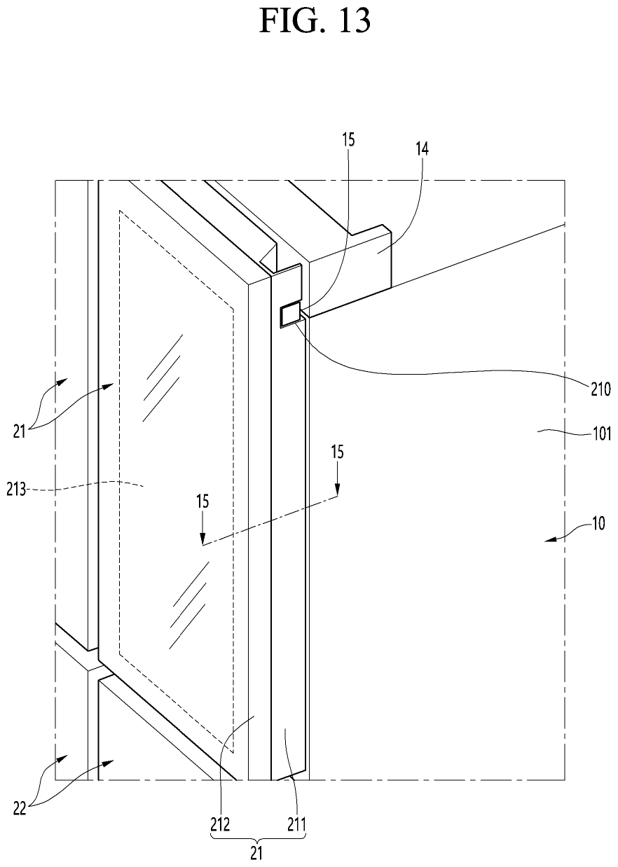

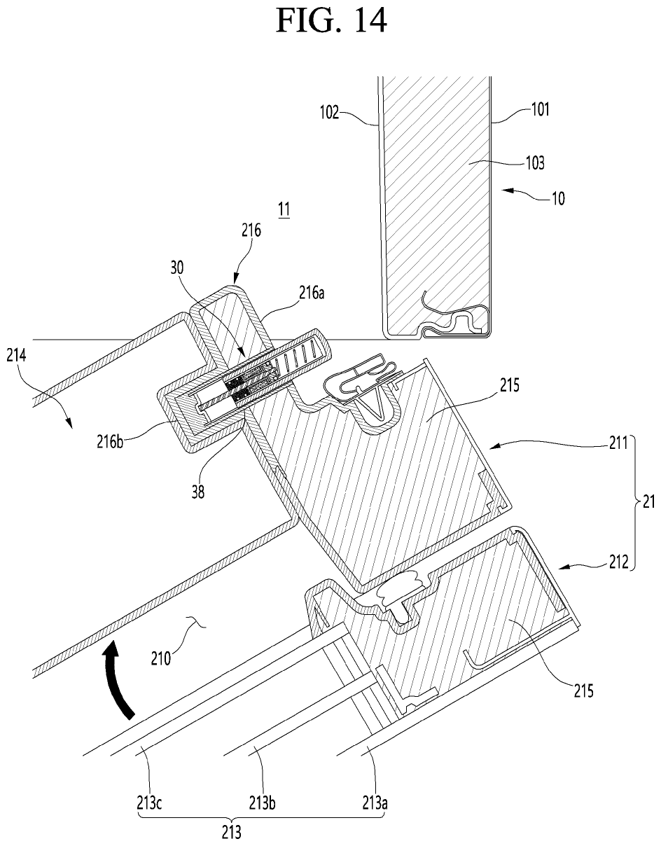

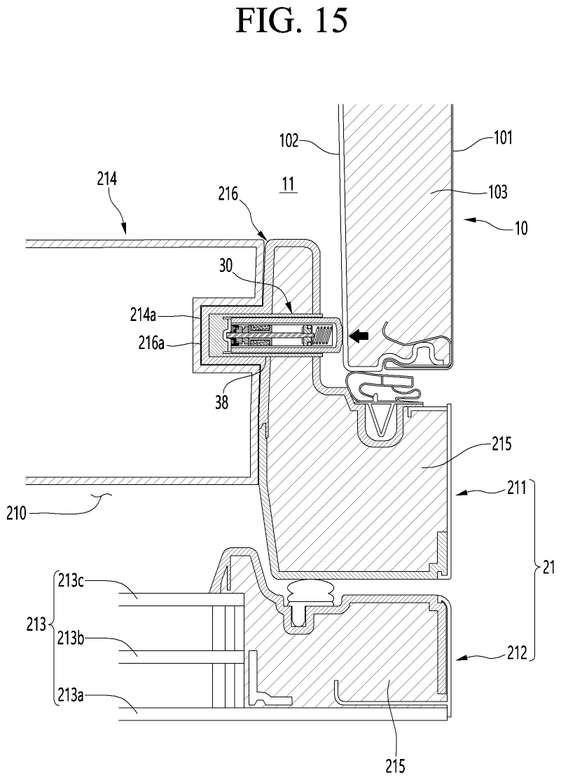

FIG. 13 is a partial perspective view illustrating a refrigerator according to a fifth embodiment of the present disclosure, FIG. 14 is a cross-sectional view taken along line 15-15 of FIG. 13 when the door of the refrigerator is opened, and FIG. 15 is a cross-sectional view taken along line 15-15 of FIG. 13 when the door is closed.

As illustrated, the refrigerator according to the fifth embodiment of the present disclosure may include a cabinet 10 and a door 20.

The cabinet 10 may include an outer case 101 forming the outer appearance, an inner case 102 forming a storage space 11, and an insulation material 103 filled between the outer case 101 and the inner case 102.

The cabinet 10 is provided with a hinge 15, and the upper and lower ends of the door 20 may be supported by the hinge 13.

There may be a plurality of doors 20, and the storage space can be opened and closed by the plurality of doors 20. As an example, the door 20 may be composed of an upper door 21 and a lower door 22.

In addition, at least one of the doors 20 may include the main door 211 and a sub-door 212 in front of the main door 211. Additionally, an opening 210 communicating with the storage space 11 may be formed in the main door 211. Additionally, the sub-door 212 may be equipped with a panel assembly 213 composed of a plurality of glass panels 213a, 213b, and 213c. Accordingly, the inside of the opening 210 can be seen through the panel assembly 213.

The inner surfaces of the main door 211 and the sub-door 212 may also be filled with insulation material 215.

Meanwhile, a storage member 214 may be mounted on the main door 211. As an example, the storage member 214 may have a basket shape. Additionally, a storage member mounting part 216b may be formed to protrude on the inner surface of the opening 210. The storage member mounting part 216b may be formed on both sides of the opening 210 to face each other, and may be coupled to both sides of the storage member 214 to allow the storage member 214 to be mounted.

Meanwhile, a damping device 30 may be installed on the main door 211. The structure and shape of the damping device 30 may be the same as the above-described embodiment. However, the damping device 30 may be mounted inside the main door 211. In addition, the push member 31 may protrude through the outside of the door 20.

The damping device 30 may be mounted to penetrate the door dike 216a protruding from the main door 211. The door dike 216a may be formed by protruding a portion of the door liner 216 that forms the rear surface of the main door 211. Additionally, the door dike 216a may protrude rearward from the rear of the main door 211 and may be spaced apart from each other to form a space in which the storage member 214 is disposed. Additionally, the storage member mounting part 216b may be formed on both sides of the door dike 216a.

In detail, the damping device 30 may be disposed on the storage member mounting part 216b. One end of the damping device 30 may be in contact with the storage member mounting part 216b and may be disposed to pass between the storage member mounting part 216b and the door dike 216a. Additionally, the push member 31 may pass through the outer surface of the door dike 216a and protrude to the outside. At this time, the protruding distance of the push member 31 may be longer than the distance between the door dike 216a and the inner case 102 when the main door 211 is closed.

The damping device 30 may be disposed horizontally parallel to the front surface of the door 20, and the end portions of the inner case 102 and the push member 31 can be disposed to be in contact with each other in the process of closing the door 20. Of course, the damping device 30 may be inclined to have a predetermined angle relative to the front surface of the door 20. Additionally, the damping device 30 may be disposed perpendicular to the left and right side walls of the storage space.

When the door 20 of the refrigerator 1 having this structure is closed from an open state to a set angle or less, the door dike 216a is inserted into the storage space 11, and the end portion of the protruding push member 31 starts to be in contact with the inner case 102.

Then, when the door 20 is rotated in a further closing direction, the push member 31 moves to the left, and the piston 33 and rod 34 move. In addition, the damping device 30 generates a damping force due to oil resistance generated as the oil in the buffer space 320 flows through the orifice. Accordingly, the door 20 is closed smoothly as the rotation speed is reduced.

When the door 20 is completely closed, as illustrated in FIG. 13, the push member 31 is fully inserted into the door dike 216a, and the end portion of the push member 31 maintains a state of being in contact with the inner case 102.

Meanwhile, the present disclosure may be possible in various other embodiments in addition to the above-described embodiments. Other embodiments of the present disclosure have differences in the structure of the damping device. A damping device according to another embodiment of the present disclosure may be applied to the refrigerator of the above-described embodiments.

Hereinafter, the description will focus on the features of another embodiment of the present disclosure, and detailed description and illustration of the same configuration as the above-described embodiment may be omitted.

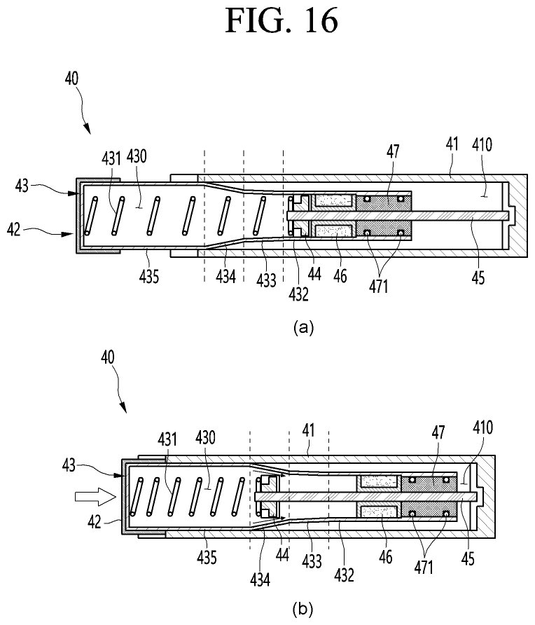

FIG. 16 is a cross-sectional view illustrating the structure of a damping device for a refrigerator according to the sixth embodiment of the present disclosure.

In FIG. 16, (a) illustrates the state of the damping device 40 in which no external force is applied to the rod 45 of the damping device. In addition, in FIG. 16, (b) illustrates the state of the damping device 40 in which the rod 45 is retracted to the maximum thereof state due to an external force being applied to the rod 45.

As illustrated, the damping device 40 of the sixth embodiment of the present disclosure may include a cylinder 43, a piston 44, and a rod 45.

The cylinder 43 may form a buffer space 430 in which oil is accommodated, and one side may be open. In addition, one open surface may be shielded by a sealing cap 47. Additionally, a seal 471 may be provided around the sealing cap 47 to prevent oil leakage. A plurality of seals 471 may be provided.

Additionally, a sponge 46 may be provided in the buffer space 430. The rod 45 penetrates the sealing cap 47 and the sponge 46 and may extend from the inside of the buffer space 430 to the outside. At this time, the sealing cap 47 and the sponge 46 may maintain a fixed position in the cylinder 43. In addition, a piston 44 that moves together with the rod 45 may be provided at the end portion of the rod 45.

A spring 431 may be provided inside the buffer space 430 between the piston 44 and the cylinder 41. Both ends of the spring 431 support the inner surface of the cylinder 43 and the piston 44, and may be compressed when the piston 44 moves. Therefore, when no external force is provided to the rod 45, the piston 44 can be returned to the state illustrated in (a) of FIG. 16 by the spring 431.

The damping device 40 may further include a housing 41. The housing 41 forms an accommodation space 410 whose one side is open, and at least a portion of the cylinder 41 may be accommodated inside the accommodation space 410.

The housing 41 may be fixedly mounted on the hinge cover 15 or the door 20. Accordingly, while, when the door 20 is closed, the damping device 40 is selectively in contact with the door 20 or the inner case 102 and the cylinder 43 is inserted into the housing 41, the damping device may be compressed to provide a damping force to the door 20.

In addition, the damping device 40 may further include a push member 42. The push member 42 may be pressed by being in contact with the door 20 or the inner case 102. The cylinder 43 may be coupled with the push member 42. The cylinder 43 and the push member 42 may be formed as one piece. Additionally, the push member 42 coupled with the cylinder 43 may be mounted inside the housing 41.

Meanwhile, the inner surface of the cylinder 43 may include a first damping part 432. The damping force generated when the piston moves within the first damping part 432 may be referred to as a first damping force.

The cylinder may include a second damping part 433 extending from the first damping part 432. The inner diameter of the second damping part 433 may be larger than the inner diameter of the first damping part 432. The inner diameter of the second damping part 433 may increase as the distance from the first damping part 432 increases. In other words, the second damping part 433 may be inclined with respect to the first damping part 432. The damping force generated when the piston moves within the second damping part 433 may be referred to as the second damping force. The second damping force is smaller than the first damping force.

The cylinder may further include a third damping part 434 extending from the second damping part 433. The inner diameter of the third damping part 434 may increase as the distance from the second damping part 433 increases. In other words, the third damping part 434 may be inclined with respect to the second damping part 433. At this time, the inclination angle of the third damping part 434 with respect to the first damping part 432 may be greater than the inclination angle of the second damping part 433 with respect to the first damping part 432. The damping force generated when the piston moves within the third damping part 434 may be referred to as a third damping force. The third damping force is smaller than the second damping force.

The cylinder may further include a fourth damping part 435 extending from the third damping part 434. The inner diameter of the fourth damping part 435 may be larger than the inner diameter of the third damping part 434. Alternatively, the inner diameter of the fourth damping part 435 may be the same as the maximum inner diameter of the third damping part 434. The inner diameter of the fourth damping part 435 may be constant in the longitudinal direction or may increase as the distance from the third damping part 434 increases. The damping force generated when the piston 44 moves within the fourth damping part 435 may be referred to as the fourth damping force. The fourth damping force is smaller than the third damping force.

In the present embodiment, as the inner diameter of the cylinder 41 increases, the amount of oil flowing through the flow path (orifice) formed between the inner peripheral surface of the cylinder 41 and the piston 44 increases, thereby reducing the damping force.

Therefore, in the case of the present embodiment, a damping force is generated in a certain section where the door 20 is closed, and the generated damping force can be gradually reduced.

In the present embodiment, the cylinder 43 includes four parts with different inner diameters as an example, but the idea of the present disclosure is to clarify that the cylinder 43 includes two or more parts with different inner diameters. Additionally, the lengths of each of the damping parts may be different from each other and may be determined to appropriately distribute the damping force.

The damping device 40 sequentially provides multiple stages of damping force, thereby gradually reducing the damping force in the process of closing the door 20, allowing the door 20 to close more smoothly. In addition, in the final section where the door 20 is completely closed, the damping force is set to the lowest to ensure that the door 20 can be closed more reliably.

What is claimed is:

1. A refrigerator comprising:
a cabinet having a storage space;
a door configured to open and close the storage space;
a hinge connecting the door to the cabinet;
a hinge cover configured to cover at least a portion of the hinge; and
a damper located at the hinge cover, the damper being configured to contact one of the door or the hinge cover to provide a damping force to the door when the door rotates in a closing direction to close the storage space.

2. The refrigerator of claim 1, wherein the hinge is located at an upper surface of the cabinet, and
wherein a rear surface of the door includes a hinge mounting part recessed inward at an upper portion of the door, the hinge being rotatably coupled to the hinge mounting part.

3. The refrigerator of claim 2, wherein the hinge cover includes:
a first portion configured to accommodate the hinge therein, the first portion protruding towards a front of the cabinet; and
a second portion protruding from the first portion, the damper being located at the second portion, and
wherein the first portion protrudes further forward than the second portion so as to define a stepped portion.

4. The refrigerator of claim 3, wherein an upper end of the hinge mounting part is located between an upper end of the first portion and an upper end of the second portion when the door is closed, and
wherein the damper is configured to contact the rear surface of the door above the hinge mounting part when the door is closed.

5. The refrigerator of claim 3, wherein the damper is located inside the second portion, and
wherein the damper includes a push member configured to contact the rear surface of the door when the door is closed, the push member protruding through a front surface of the second portion.

6. The refrigerator of claim 3, wherein the damper extends through the second portion, the damper being configured to selectively contact an inner surface of the hinge mounting part.

7. The refrigerator of claim 6, wherein the first portion and the second portion extend into the hinge mounting part when the door is closed.

8. The refrigerator of claim 6, wherein the damper includes a push member extending through the second portion, the push member being configured to be retracted towards the cabinet when the push member contacts the inner surface of the hinge mounting part when the door is closed, the push member having a contact portion at a front end of the push member, and
wherein the inner surface of the hinge mounting part includes a guide portion having a shape corresponding to a shape of the contact portion.

9. The refrigerator of claim 8, wherein the guide portion is inclined or rounded such that the guide portion extends away from the rear surface of the door and extends closer towards a rotation center of the hinge the further the guide portion is away from the rear surface of the door.

10. The refrigerator of claim 6, wherein the second portion protrudes upward from an upper surface of the first portion.

11. The refrigerator of claim 6, wherein the second portion protrudes from a side surface of the first portion, the side surface being closer to an outside of the cabinet among a left surface and a right surface of the first portion.

12. The refrigerator of claim 1, wherein the damper includes:
a cylinder having a space to accommodate oil therein, the cylinder having a first end and a second end, the first end having an opening;
a push member on the cylinder, the push member extending through the hinge cover to be movable relative to the hinge cover while in contact with a rear surface of the door as the door is opened or closed;
a sealing cap configured to seal the opening of the cylinder;
a rod extending through the sealing cap from inside the cylinder;
a piston coupled to the rod, the piston configured to move within the space of the cylinder; and
an elastic member located in the space of the cylinder, the elastic member configured to apply an elastic force to the piston.

13. The refrigerator of claim 12, wherein the cylinder includes a plurality of damping regions between the first end of the cylinder and the second end of the cylinder,
wherein at least one damping region has a larger diameter relative to another damping region located between the at least one damping region and the first end of the cylinder, and
wherein the damping force gradually decreases as the piston is retracted.

14. The refrigerator of claim 13, wherein the damping force provided in one damping region of the plurality damping regions closest to the first end reduces a rotational speed of the door as the door closes.

15. A refrigerator comprising:
a cabinet having a storage space;
a door configured to open and close the storage space;
a door dike protruding rearward from a rear surface of the door, the door dike being configured to be inserted into the storage space when the door is closed; and
a damper located at the door dike, the damper being configured to come into contact with the cabinet to providing a damping force to the door when the door rotates in a closing direction to close the door.

16. The refrigerator of claim 15, wherein the damper is disposed within the door dike, and
wherein the damper includes a push member protruding through an outer surface of the door dike, the push member being configured to be brought into contact with an inner wall of the storage space when the door rotates in a closing direction to close the door.

17. The refrigerator of claim 16, further comprising a storage member located at the rear surface of the door,
wherein the door dike includes a storage member mounting part protruding therefrom to support the storage member, and
wherein the damper is located in the storage member mounting part.

18. The refrigerator of claim 17, wherein an end of the damper opposite to the push member is supported by the storage member mounting part.

19. The refrigerator of claim 16, wherein the damper extends in a direction towards the cabinet when the door is closed.

20. The refrigerator of claim 15, wherein the door includes:
a main door rotatably connected to the cabinet, the main door having an opening in communication with the storage space when the door is closed; and
a sub-door configured to open and close the opening at a front of the main door, and
wherein the door dike and the damper are located on the main door.
